(19) United States
(12) Patent Application Publication
(10) Pub. No.: US 2026/0119078 A1
(43) Pub. Date: Apr. 30, 2026

(54) HINT-BASED ASYNCHRONOUS WRITE DESTAGE

(71) Applicant: Dell Products L.P., Round Rock, TX (US)

(72) Inventors: Lixin Pang, Needham, MA (US); Ramesh Doddaiah, Westborough, MA (US); Rong Yu, West Roxbury, MA (US)

(73) Assignee: Dell Products L.P., Round Rock, TX (US)

(21) Appl. No.: 18/926,940

(22) Filed: Oct. 25, 2024

(51) Int. Cl. G06F 3/06

(52) U.S. Cl. CPC G06F 3/0659; G06F 3/0647; G06F 3/065; G06F 3/0689

(57) ABSTRACT

A method, comprising: receiving write requests at a first storage system; destaging the write requests to a permanent storage of the first storage system and collecting one or more destage statistics that are associated with the write requests; generating a hint object corresponding to the write requests, the hint object being generated based at least in part on the destage statistics; transmitting the hint object to a second storage system; and transmitting at least some of the write requests to the second storage system for remote replication.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided, comprising: receiving write requests at a first storage system; destaging the write requests to a permanent storage of the first storage system and collecting one or more destage statistics that are associated with the write requests; generating a hint object corresponding to the write requests, the hint object being generated based at least in part on the destage statistics; transmitting the hint object to a second storage system; and transmitting at least some of the write requests to the second storage system for remote replication.

According to aspects of the disclosure, a system is provided, comprising: a memory; and at least one processor that is operatively coupled to the memory, the at least one processor being configured to perform the operations of: receiving write requests at a first storage system; destaging the write requests to a permanent storage of the first storage system and collecting one or more destage statistics that are associated with the write requests; generating a first hint object corresponding to the write requests, the first hint object being generated based at least in part on the destage statistics; transmitting the hint object to a second storage system; and transmitting the write requests to the second storage system for remote replication.

According to aspects of the disclosure, a system is provided, comprising: a memory; and at least one processor that is operatively coupled to the memory, the at least one processor being configured to perform the operations of: receiving write requests from a source storage system, the write request being received for the purpose of data replication; receiving, from the source storage system, a first hint object that is associated with the write requests; and destaging the write requests based on the first hint object.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a system, according to aspects of the disclosure;

FIG. 1B is a diagram of an example of a storage system, according to aspects of the disclosure;

FIG. 2 is a flowchart of an example of a process, according to the prior art;

FIG. 3 is a flowchart of an example of a process, according to aspects of the disclosure;

FIG. 4A is a flowchart of an example of a process, according to aspects of the disclosure;

FIG. 4B is a flowchart of an example of a process, according to aspects of the disclosure; and

FIG. 5 is a diagram of an example of a computing device, according to aspects of the disclosure.

### DETAILED DESCRIPTION

In asynchronous data replication, write requests are destaged in a source storage system and subsequently replicated to a target storage system. The replication of the write requests to the target storage system involves destaging the requests on the target storage system. In other words, both the source storage system and the target storage system perform write destaging operations for the same write requests. The destaging of writes at each of the source and target storage systems is a resource-intensive process that involves multiple complex steps.

The present disclosure provides a method for improving the efficiency at which write requests are destaged at the target storage system. The method takes advantage of the redundancy between the steps that are performed at each of the source and target storage systems with respect to destaging write requests. The method involves generating a hint object that indicates the results of some of the operations that are performed by the source storage system for the purpose of destaging write requests. The hint object is transmitted from the source storage system to the target storage system. The hint object is used at the target storage system to destage write requests that are being replicated from the source storage system to the target storage system.

In simple terms, the hint object indicates the results of some of the steps that were performed at the source storage system with respect to the write requests that are being replicated (and/or other write requests). The hint object may indicate if performing deduplication on the write requests was useful or whether performing compression on the write requests was worthwhile. Furthermore, the hint object may indicate whether the write requests are likely sequential or random write requests. For example, the information in the hint object may be used by the target storage system to determine whether to perform compression or deduplication of the write requests or how to group the write requests.

The method has the following advantages over traditional methods for replicating write requests. On one hand, the method avoids redundant processing as it avoids repeating tasks, at the target storage system, which have already been performed by the source storage system. Furthermore, the method reduces unnecessary disk defragmentation performance by improving data packing efficiency, minimizes data reduction activities such as compression and deduplication, increases the probability of optimized writes, and lowers unnecessary resource consumption, such as CPU consumption, memory consumption, and fabric bandwidth consumption.

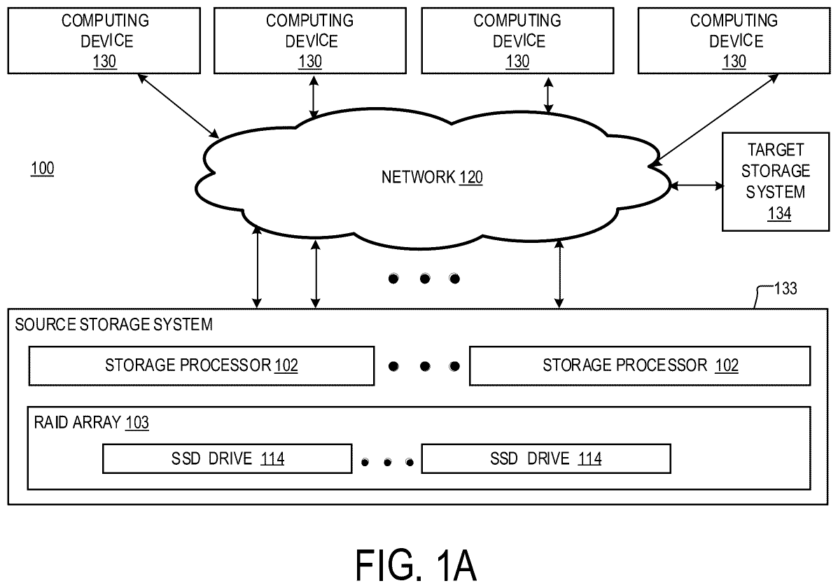

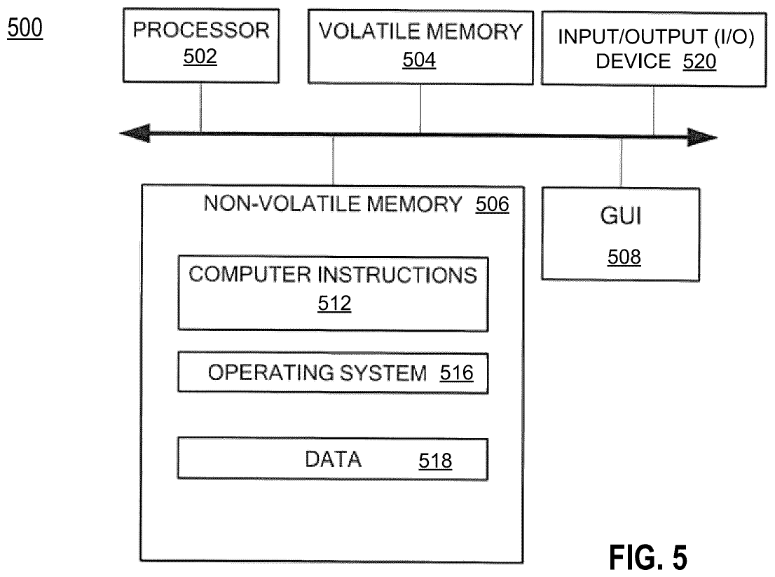

FIG. 1A is a diagram of an example of a system 100, according to aspects of the disclosure. As illustrated, system 100 may include a storage system 133 that is coupled to a plurality of computing devices 130, and a storage system 134, via a communications network 120. Each of the computing devices 130 may include a smartphone, a desktop, a server, a laptop, and/or any other device that might be used by a user to store and retrieve data from the storage system 133. Each of the computing devices may be the same or similar to the computing device 500, which is discussed further below with respect to FIG. 5. The communications network 120 may include one or more of the Internet, a local area network (LAN), a wide area network (WAN), an InfiniBand network, a mobile data network, etc. Storage system 133 may include a plurality of storage processors 102 and a plurality of storage devices 114. In some implementations, each of the storage devices 114 may include a Solid-State Drive (SSD), a Non-Volatile Memory Express (NVME) device, a hard disk, and/or any other suitable type of storage device. According to the present example, the storage devices are arranged in a RAID array 103. Each of the storage processors 102 may include a computing device, such as the computing device 500, which is discussed further below with respect to FIG. 5. Each of the storage processors 102 may be configured to receive I/O requests from the computing devices 130 and execute the received requests by reading or writing data to the RAID array 103. Storage system 134 may have the same or similar configuration as storage system 133. Under the nomenclature of the present disclosure, write requests that are executed on storage system 133 are replicated to storage system 134 to ensure data redundancy.

FIG. 1B is a diagram illustrating aspects of the operation of storage system 190, according to aspects of the disclosure. Storage system 190 may be the same or similar to either one of storage systems 133 or 134. As illustrated, the storage system 190 may include a frontend (FE) 141, a global memory (GM) 142, a data service (DS) 143, a backend (BE) 144, and a RAID array 145. FE 141 may be comprised of one or more FE directors 181. Each FE director 181 may include one or more processes that are executed on a respective one of the storage processors 102. DS 143 may be comprised of one or more DS directors 183. Each DS director 183 may include one or more processes that are executed on a respective one of the storage processors 102. BE 144 may be comprised of one or more BE directors 184. Each BE director 184 may include one or more processes that are executed on a respective one of the storage processors 102. GM 142 includes a shared memory space that is used by storage system 190 for caching data. GM 142 may include a plurality of memory portions that are united in the same address space, wherein each of the plurality of memory portions is part of the volatile memory (e.g., DRAM) of a different respective one of the storage processors 102. Although, in the present example, GM 142 is used to cache data, it will be understood that alternative implementations are possible in which GM 142 is replaced with a different type of cache memory. In other words, the present disclosure is not limited to using any specific type of cache memory.

Optionally, DS 143 may include a hint object converter 185. Converter 185 may include a machine-learning engine that implements a machine-learning model. According to the present example, the machine-learning model includes Autoregressive Integrated Moving Average (ARIMA). However, alternative implementations are possible in which the machine-learning model includes Seasonal Decomposition of Time Series (STL), Long Short-Term Memory (LSTM) and Recurrent Neural Networks (RNNs), and Prophet. In operation, the machine-learning model may receive as input a first hint object and generate a second hint object in response. The use and operation of converter 185 is discussed further below.

The FE 141, the DS 143, and the BE 144 may be configured to receive write requests and execute the write requests. The write requests may be received from client computing devices, such as the computing devices 130. Executing any write request may include: receiving the write request, storing the write requests in cache, and destaging the write requests. As used herein, the term “destaging” refers to the copying of a write request (or user data associated with the write request) into a RAID array or another type of permanent storage that is part of the storage system.

An example of one specific method for servicing incoming write requests is provided in U.S. patent application Ser. No. 18/820,867 entitled “Intelligent Relocation Destage”, which is hereby incorporated by reference herein in its entirety. As is discussed in this application, the FE 141 may maintain an address space of FE track IDs. The DS 143 may maintain an address space of BE track IDs. And the DS 143 and the BE 144 may work together to map each of the BE track IDs to a respective RAID slice in the RAID array 145. The servicing of a write request may be described briefly as follows. The write requests may be received by the FE 141. The FE 141 may assign an FE track ID to write request and cache the write request based on the track ID. The DS 143 may identify a BE track ID that corresponds to the FE track ID. The BE 144 may identify a RAID slice that corresponds to the BE track ID and copy the write request to the identified BE slice. In other words, there are multiple layers of indirection that are introduced by mapping incoming write requests to FE track IDs and BE track IDs, which permits the grouping of data in various ways that might be deemed advantageous.

Although not shown, the DS 143 may store a data structure that maps FE rack IDs to corresponding BE track IDs. Identifying a BE track ID that corresponds to a FE track ID may include one of: (1) performing a search of the data structure based on the FE track ID to retrieve a BE track ID that is already mapped to the FE track ID or (2) assigning a new write BE track ID to the FE track ID and updating the data structure to map the new BE track ID to the FE track ID. In other words, a write request may be executed based on either a BE track ID that is already assigned to the FE track ID or a new BE track ID that is assigned to the FE track ID specifically for the purpose of completing the write request. If a write request is executed by using a BE track ID that is already assigned to the FE track ID of the write request, the write request is said to be destaged by using an in-place write. If a write request is executed by assigning a new BE track ID to the FE track of the write request and using the new BE track ID to destage the write request, the write request is said to be destaged by using a relocation write.

In general, the BE track ID that is used to destage a write request determines the RAID slice (or other location) in the RAID array 145 where the write request is going to be destaged. If a write request is part of a sequential write pattern, it is advantageous to destage the write request by using a relocation write. Destaging the write request in this manner may help ensure that the write request would be stored in the same RAID slice with other write requests from the same sequence of write requests. Storing write requests from the same sequence in the same RAID slice is advantageous because it makes defragmentation and storage space reclamation of the RAID array 145 more efficient. On the other hand, if the write request is part of a random write it may be more efficient to execute the write request by using an in-place write.

When a write request is destaged, DS 145 has to make a number of decisions that pertain to the destaging of the write request. By way of example, the decisions may include: (i) whether to use a relocation write or in-place write to complete the write request, (ii) whether to use compression in completing the write request, (iii) what type of compression to use when completing the write request, and/or (iv) whether to use a deduplication path or a non-deduplication path to store the write request.

In addition to destaging a write request, the storage system 190 may also replicate the write request. The replication may be performed for data duplication purposes to prevent data loss in the event of a failure in storage system 190. Replicating the write request may include transmitting the write request to a target storage system. The target storage system may have the same or similar configuration to storage system 190. Upon receiving he write request, the target system may destage the write request in the same manner as discussed above with respect to storage system 190. In other words, the target storage system may make the same set of decisions as storage system 190. The set of decisions that is made at each of storage system 190 and the target storage system is herein referred to as “destaging decisions”.

The replication of write requests may be performed asynchronously. Specifically, storage system 190 may group write requests in batches and send each batch of write requests to the target system at once (or in close temporal proximity). Each batch of write requests may include write requests that are received during a different replication period.

Each batch of write requests that is transmitted from storage system 190 to the target storage system may include write requests that have already been destaged at storage system 190. In this regard, the DS 143 would have sufficient time to make some observations of how successful some of the destaging decisions were that were made. For example, DS 143 may be able to observe the compression ratio for each (or at least some) of the write requests in the batch that resulted when the write requests were compressed. As another example, DS 143 may be able to observe if any of the write requests is part of a sequential write pattern or a random write pattern. As another example, DS 143 may be able to observe how likely is a write request to be successfully deduplicated. In some implementations, these observations may pertain to write requests that are destaged during the most recent replication period. In other implementations, the observations may span multiple replication periods (or a previous replication period).

As a result of making the above observations, DS 143 may derive one or more of the following information items. For example, DS 143 may determine the average compression ratio for a set of write requests. Additionally or alternatively, DS 143 may determine the (observed) probability of a write request from the set being successfully deduplicated. Additionally or alternatively, DS 143 may determine the probability of a write request from the set being relocated. Additionally or alternatively, DS 143 may classify the set of write requests as being part of a sequential write pattern or a random write pattern. For example, if 60% or more of the write requests are determined to be part of a sequential write pattern, DS 143 may classify the entire set as being part of a sequential write pattern. Otherwise, if fewer than 60% of the write requests are part of a sequential write pattern, DS 143 may classify the write as part of a random write pattern. The set of write requests may include write requests that are received during the most recent replication period (i.e., write requests from the same replication batch) or write requests that are received from multiple replication periods (i.e., write requests from multiple replication batches). For ease of description, the information items that are discussed are herein referred to as “destage statistics.” The phrase “obtaining replication statistics” may refer to obtaining only one of the data items or obtaining multiple ones of the data items.

As noted above, after the end of each replication period, storage system 190 may transmit to the target storage system a batch of write requests. The batch of write requests may include only (or mostly) write requests that are received during the replication period. The write requests in the batch may be transmitted separately from each other to the target storage system and/or in any other suitable manner. Upon receiving the write requests, the target storage system may execute the write requests locally, in the same way they were executed at storage system 190. As a result of this arrangement, a separate copy of the user data associated with the write requests is created at the target storage system, in addition to the copy that is created in storage system 190.

In some implementations, storage system 190 may generate a hint object that includes one or more of the destage statistics that are discussed above. In some implementations, storage system 190 may provide a different respective hint object with each batch of write requests that is transmitted to the target storage system. The hint object may be generated based only on information that is collected (or observed) for the write requests in the batch. For example, the hint object may include the average compression ratio of the write requests in the batch (as it is measured at storage system 190). As another example, the hint object may include an indication of whether the write requests in the batch are classified as being part of a sequential write pattern or a random write pattern. As another example, the hint object may include an indication of the probability, that is observed for the write requests in the batch, of any of the write requests in the batch being successfully deduplicated. As another example, the hint object may include an indication of the probability, that is observed for the write requests in the batch, of any of the write requests in the batch being relocated.

Alternatively, the hint objects may include information that is collected (or observed) for a set of write requests that includes write requests from the current batch (i.e., write requests received during the most recent replication period that has passed) as well as write requests that were received during previous replication periods. For example, the hint object may include the average compression ratio of the write requests in the set (as it is measured at storage system 190). As another example, the hint object may include an indication of whether the write requests in the set are classified as being part of a sequential write pattern or a random write pattern. As another example, the hint object may include an indication of the probability, that is observed for the write requests in the set, of any of the write requests in the set being successfully deduplicated. As another example, the hint object may include an indication of the probability, that is observed for the write requests in the set, of any of the write requests in the set being relocated.

The target storage system may use the hint object that is provided by storage system 190 when destaging the write requests in the batch. By way of example, for one or more (or all) of the write requests in the batch, the target storage system may use the hint object as a basis for: (i) deciding whether to perform compression on the write request(s) before destaging it, (ii) deciding whether to use a deduplication path or non-deduplication path for destaging the write request (s), (iii) deciding whether to use an in-place write or a relocation write for executing the write request(s), (iv) deciding what slice-based write objects to use for executing the write request(s), and (v) deciding whether to use a sequential write path or a relocation write path for executing the write request(s).

For example, if the hint object includes an indication of a low compression ratio (i.e., a compression ratio below a compression ratio threshold), the target storage system may decide to destage the write request(s) from the batch without first compressing the user data that is part of the write request(s). On the other hand, if the hint object includes an indication of a high compression ratio (i.e., a compression ratio above a compression ratio threshold), the target storage system may decide to destage the write request(s) from the batch without first compressing the user data that is part of the write request(s). In some implementations, the indication of an expected compression ratio that is contained in the hint object may be generated based on the individual compression rations of a plurality or write requests. For example, the indication of compression ratio may be the average of the compression ratios, the mean of the compression ratios, and so forth.

As another example, if the hint object includes an indication of a low probability of deduplication (i.e., a probability below a probability threshold), the target storage system may decide to destage the write request(s) from the batch by using a non-deduplication path. On the other hand, if the hint object includes an indication of a high deduplication probability (i.e., a probability above the probability threshold), the target storage system may decide to destage the write request(s) from the batch by using a deduplication path. In some respects, using the deduplication path may require more system resources than using the non-deduplication path. In this regard, the hint object may be used to conserve system resources when there is a low probability that using the deduplication path would yield benefits.

A definition is now provided of using a deduplication path versus using a non-deduplication path to execute a write request. Data deduplication refers is a method for storing data that is practiced in content-addressable storage systems. Data deduplication is well understood in the art. Consider an example in which a write request requires a block of user data to be stored at a given logical block address (LBA). Using a data deduplication path for executing the write request may include: generating a hash digest for the block of user data, comparing the hash digest to existing hash digests, if any of the existing hash digests match the instant hash digest, matching the given LBA to the existing hash digest and to a physical storage location that is mapped to the existing hash digest, and if none of the existing hash digests matches the instant hash digest, mapping the instant hash digest to a new storage location, storing the user data block at the new storage location, and mapping the given LBA to the new hash digest and/or the new storage location. Executing the write request by using a non-deduplication path may include: generating a hash digest, storing the block of user data at a new storage location, and mapping the LBA to the new storage location and/or hash digest. In this example, the non-deduplication path involves using a content-addressable scheme to store the user data, but it omits elements that are related to comparing the user data (or its hash digest) to other data (or its hash digests) that is already stored in the storage system and/or mapping the given LBA to an instance of the user data that has already been stored in the storage system. Alternatively, executing the write request by using a non-deduplication path may include executing the write request by using a location-addressed scheme.

The probability of deduplication of a write request may be the probability that the write request would be deduplicated successfully. In some implementations, a write request may be deduplicated successfully if the user data that is part of the write request has already been stored in storage system 190 (as a result of it being received in a prior write request also) and the write request can be executed by mapping the LBA associated with the write request to the physical storage location where the user data is stored. In some implementations, the probability of deduplication that is contained in the hint object may be determined based on a count of how many of the write requests in a set of write requests that is associated with the hint object have been deduplicated successfully when the write requests were executed by using a deduplication path at storage system 190.

As yet another example, if the hint object includes an indication of a low relocation probability (i.e., a probability below a probability threshold), the target storage system may decide to destage the write request(s) by using in-place writes. On the other hand, if the hint object includes an indication of a high relocation probability (i.e., a probability above the probability threshold), the target storage system may decide to destage the write request(s) from the batch by using relocation writes. As can be readily appreciated, using relocation writes is more resource-intensive than using in-place writes. In this regard, the hint object may be used to conserve system resources by ensuring that relocation writes are performed for write requests that are deemed likely to be relocated soon anyway, while in-place writes are performed for those that are deemed not likely.

The probability of relocation of a write request may be the probability that the write request would be relocated from one location in RAID array 145 to a different location in RAID array 145. For example, it may be the probability that the write request would be relocated from one slice in the RAID array 145 to a different slice. The relocation may be performed as part of defragmentation or storage space reclamation of RAID array 145. In some implementations, the probability of relocation that is contained in the hint object may be determined based on a count of how many of the write requests in a set of write requests had to be relocated after they were initially stored in RAID array 145.

As yet another example, if the hint object indicates that the write requests in the batch are part of a sequential write pattern, the target storage system may use a sequential write path. On the other hand, if the hint object indicates that are write requests are part of a random write pattern, the target storage system may use a random write path. Using a sequential write path may include destaging the write requests by using relocation writes. Using a non-sequential write path may include destaging the write requests by using in-place writes. In general, using relocations writes may ensure that a write request would be grouped with other write requests from the same sequence (because of the way RAID slices are packed).

The example above describes a scenario in which a target storage system receives a first hint object from the storage system and uses the first hint object to destage one or more write requests. However, in an alternative implementation, the target storage system may transform the first hint object into a second hint object and use the second hint object as a basis for the destaging of the write requests.

The transformation of the first hint object to the second hint object may account for differences between the operation of storage system 190 and the operation of the target storage system. For example, the target storage system and storage system 190 may use different compression algorithms. In this regard, an indication of an expected compression ratio that is provided in the first hint object may not represent adequately the results that could be expected from the compression algorithm used in the target source system. In this regard, converting the first hint object to the second hint object may yield the result of converting a first expected compression ratio value that is part of the first hint object into a second compression ratio value that more accurately represents the compression results that could be achieved if the write requests were to be compressed by the algorithm used in the target storage system.

Similarly, the relocation probability that is calculated by the storage system 190 may not apply equally to the operation of the target storage system because the target storage system may use a different defragmentation algorithm or other algorithms that determine where data is stored. In this regard, converting the first hint object to the second hint object may yield the result of converting a first relocation probability value that is part of the first hint object into a second relocation probability value that is more closely applicable to the operation of the target storage system.

The conversion of the first hint object into the second hint object may be performed by using a hint object converter. The hint object converter may be the same or similar to the hint object converter 185, which is discussed above with respect to FIG. 1B. The hint object converter 185 may implement a machine-learning model, such as ARIMA. In one example, the hint object converter may receive, as input, a first hint object, and produce, as output, a second hint object. Optionally, in some implementations, in addition to the hint object, the object converter may receive as input information that is indicative of the current context of the target storage system. Such information may identify one or more of (i) a compression algorithm that is used by the target storage system, (ii) the current load of the target storage system (measured in IOPs), (iii) available cache space in the target storage system, (iv) available storage space in the RAID array where the write requests are going to be destaged, the type of the RAID array (e.g., 3+1, 7+2, etc.), (iv) an identifier of a defragmentation algorithm used by the RAID array and/or any other suitable information.

The machine-learning model may be trained in any suitable manner. In one example, the machine-learning model may be trained by using supervised learning. The supervised learning may be performed based on a training data set. The training data set may include a plurality of training data items. Each training data item may include a first hint object and a second hint object. The first hint object may serve as an input to the machine-learning model (during training) and the second hint object may serve as a label. The first hint object may be generated by storage system 190 for a batch of write requests. The second hint object may be generated by the target storage system for the same batch of the write requests (after the write requests are destaged at the target storage system). Both the first and second hint objects may be generated in the manner that is discussed above. However, the second hint object may be generated independently of the first hint object.

A hint object may be any suitable representation of at least one destage statistic. By way of example, a hint may include a number, a string, or an alphanumerical string. As another example, the term hint object may include a plurality of numbers, a plurality of strings, and/or a plurality of alphanumerical strings. In addition to destage statistics, the hint object may include metadata that identifies the storage system where the hint object was generated, the time when the hint object was generated, and/or any other suitable information.

As noted above, a hint object may contain one or more destage statistics. In the example above, each of the statistics was derived based on the same sample set of write requests that were executed at storage system 190. However, in alternative implementations, at least two statistics in the same hint object may be generated based on different sample sets. For example, the indication of an average compression ratio that is part of the hint object may be calculated based on the respective compression ratios of a first set of write requests and the indication of deduplication probability that is part of the same hint object may be generated based on a second sample set of write requests that is large than the first set. For example, the first set of write requests may include only write requests that were received at storage system 190 during the most recent (completed) replication period, whereas the second set may include write requests that were received during earlier replication periods as well.

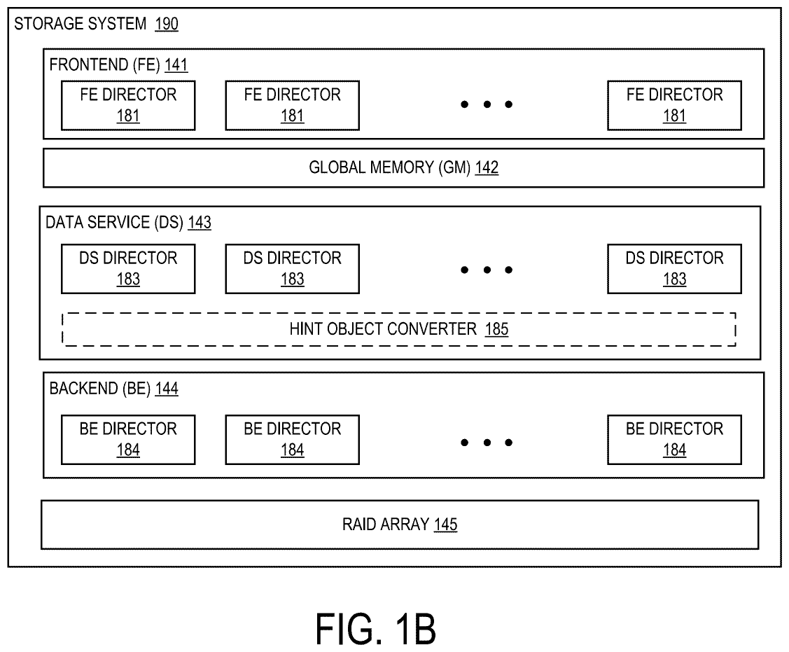

FIG. 2 is a flowchart of an example of a process 200 that is performed by a storage system, according to the prior art. At step 202, the storage system detects the start of a replication cycle. At step 204, the storage system receives a plurality of write requests. According to the present example, the write requests are received sequentially. At step 206, the storage system destages the write requests as they are being received. At step 208, the storage system detects the end of the replication cycle. At step 210, in response to detecting the end of the replication cycle, the storage system transmits the write requests to a target storage system for replication.

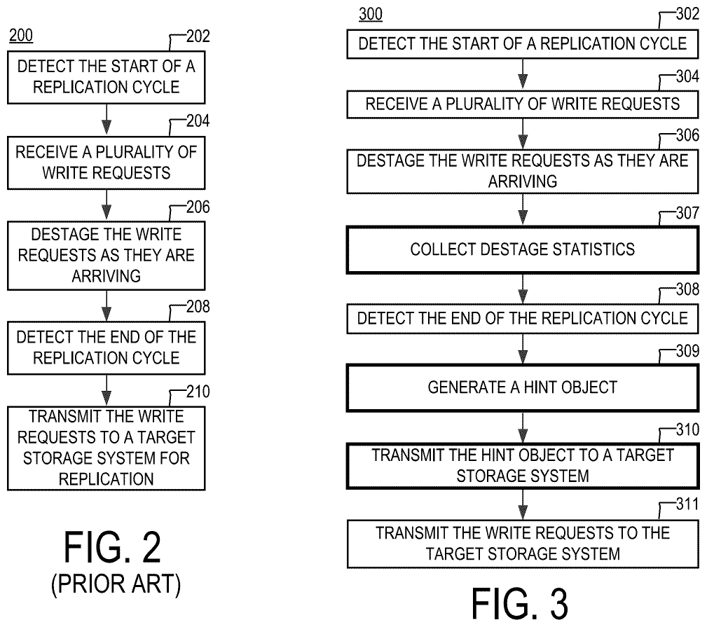

FIG. 3 is a flowchart of an example of a process 300, according to aspects of the disclosure. According to the present example, process 300 is performed by a DS 143 of storage system 190. However, the present disclosure is not limited to any specific part of a storage system performing any of the steps in process 300. For example, in some implementations, one or more of the steps in process 300 may be performed by FE 141 and/or BE 144 of storage system 190.

At step 302, DS 143 detects the start of a replication cycle.

At step 304, a plurality of write requests is received at storage system 190. According to the present example, the write requests are received sequentially. The plurality of write requests that is the subject of this example may include all write requests that are received at storage system 190 during the replication period or fewer than all write requests.

At step 306, DS 143, destages the write requests. According to the present example, the write requests are destaged with the help of FE 141 and/or BE 144. According to the present example, the write requests are destaged roughly in the order in which they are received.

At step 307, DS 143 collects destage statistics. According to the present example, DS 143 collects one or more of the destage statistics that are discussed above with respect to FIG. 1B.

At step 308, DS 143 detects the end of the replication cycle. In response to detecting the end of a replication cycle, DS 143 goes on to execute steps 309-311.

At step 309, DS 143 generates a hint object based on the collected destage statistics. According to the present example, the hint object is the same or similar to the hint object which is discussed above with respect to FIG. 1B. According to the present example, the hint object is generated in the manner discussed above with respect to FIG. 1B.

At step 310, the hint object (generated at step 309) is transmitted to the target storage system.

At step 311, at least some of the plurality of write requests (received at step 304) are transmitted to a target storage system.

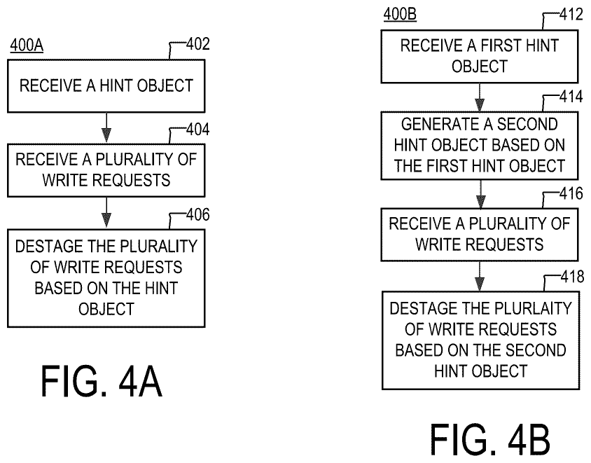

FIG. 4A is a flowchart of an example of a process 400A, according to aspects of the disclosure. According to the present example, process 400A is performed by a DS 143 of storage system 190. However, the present disclosure is not limited to any specific part of a storage system performing any of the steps in process 400A. For example, in some implementations, one or more of the steps in process 400A may be performed by FE 141 and/or BE 144 of storage system 190.

At step 402, a hint object is received by storage system 190.

At step 404, a plurality of write requests are received by storage system 190. The plurality of write requests is transmitted by a source storage system for the purpose of the plurality of write requests being replicated at storage system 190. The plurality of write requests may be transmitted to storage system 190 as a result of the source storage system executing a process that is the same or similar to process 300, which is discussed above with respect to FIG. 3. The plurality of write requests may include all or fewer than all of the write requests that are accumulated at the source storage system during a given replication period. Additionally or alternatively, the plurality of write requests may include only write requests that are accumulated during the given replication period.

In some implementations, the hint object (received at step 402) may be associated with the plurality of write request (received at step 404). The hint object may be generated in the manner discussed above with respect to FIG. 1B. In some implementations, the hint object may have the format that is discussed above with respect to FIG. 1B. In some implementations, the hint object may be generated based only on destage statistics that are collected for the plurality of write requests (and/or all write requests that are received at the source storage system during the same replication period as the plurality or writer request). Alternatively, in some implementations, the hint object is generated based on destaging statistics that are collected for multiple batches of write requests. Additionally or alternatively, in some implementations, the hint object may be generated based on destage statistics for a different batch of write requests than the one received at step 402.

At step 406, the plurality of write requests is destaged based on the hint object. In some implementations, the destaging may be performed in the manner discussed above with respect to FIG. 1B.

FIG. 4B is a flowchart of an example of a process 400B, according to aspects of the disclosure. According to the present example, process 400B is performed by a DS 143 of storage system 190. However, the present disclosure is not limited to any specific part of a storage system performing any of the steps in process 400B. For example, in some implementations, one or more of the steps in process 400B may be performed by FE 141 and/or BE 144 of storage system 190.

At step 412, a first hint object is received by storage system 190. In some implementations, the first hint object may be associated with the plurality of write requests. The first hint object may be generated in the manner discussed above with respect to FIG. 1B. In some implementations, the first hint object may have the format that is discussed above with respect to FIG. 1B. In some implementations, the first hint object may be generated based only on destage statistics that are collected for the plurality of write requests. Alternatively, in some implementations, the first hint object is generated based on destaging statistics that are collected for multiple batches of write requests. Additionally or alternatively, in some implementations, the first hint object may be generated based on destage statistics for a different batch of write requests than the one received at step 402.

At step 414, a second hint object is generated based on the first hint object. The second hint object may be generated by using a converter that implements a machine-learning model, such as the hint object converter 185, which is discussed above with respect to FIG. 1B.

Additionally or alternatively, in some implementations, the second hint object may be generated by using rule-based logic. The rule-based logic may be executed on storage system 190. For example, the first hint object may include an indication of a first compression ratio and the second hint object may include an indication of a second compression ratio. The second compression ratio may be generated by executing a rule that is part of the rule-based logic, wherein the rule provides that the second compression ratio should be generated by multiplying the first compression ratio by a predetermined first scaling factor. As another example, the first hint object may include an indication of a first relocation probability and the second hint object may include an indication of a second relocation probability. The second relocation probability may be generated by executing a rule that is part of the rule-based logic, wherein the rule provides that the second relocation probability should be generated by multiplying the first relocation probability by a predetermined second scaling factor. The second scaling factor may be the same or different from the first scaling factor. The first scaling factor and/or the second scaling factor may be determined by observing the operation of storage system 190 and detecting how closely the compression ratios achieved at the source storage system match those at storage system 190 or how similar the relocation probabilities at the source storage system are to those at storage system 190. In some implementations, the second hint object may include at least one parameter (such as relocation probability) whose value is different from the value of the same parameter in the first object and whose value is derived from the value of the same parameter in the first object. The second hint object may or may not include at least one parameter value that is the same as the value of the same parameter that is specified in the first hint object.

At step 416, a plurality of write requests are received by storage system 190. The plurality of write requests is transmitted by a source storage system for the purpose of the plurality of write requests being replicated at storage system 190. The plurality of write requests may be transmitted to storage system 190 as a result of the source storage system executing a process that is the same or similar to process 300, which is discussed above with respect to FIG. 3. The plurality of write requests may include all or fewer than all of the write requests that are accumulated at the source storage system during the same replication period.

At step 418, the plurality of write requests is destaged based on the second hint object. In some implementations, the destaging may be performed in the manner discussed above with respect to FIG. 1B.

Referring to FIG. 5, in some embodiments, a device 500 may include processor 502, volatile memory 504 (e.g., RAM), non-volatile memory 506 (e.g., a hard disk drive, a solid-state drive such as a flash drive, a hybrid magnetic and solid-state drive, etc.), graphical user interface (GUI) 508 (e.g., a touchscreen, a display, and so forth) and input/output (I/O) device 520 (e.g., a mouse, a keyboard, etc.). Non-volatile memory 506 stores computer instructions 512, an operating system 516 and data 518 such that, for example, the computer instructions 512 are executed by the processor 502 out of volatile memory 504. Program code may be applied to data entered using an input device of GUI 508 or received from I/O device 520.

FIGS. 1-5 are provided as an example only. At least some of the tasks discussed with respect to FIGS. 1-5 may be performed in parallel, in a different order, or altogether omitted. In some implementations, a write request may include user data and a metadata. The user data may be the data that is desired to be stored when the write request is executed. The metadata may include the logical address where the data is desired to be stored, the logical unit where the data is desired to be stored and/or any other suitable information. The phrase “transmitting a write request” as used throughout the disclosure may mean transmitting the user data of the write request, transmitting the entire write request, or transmitting the metadata of the write request. Similarly, the phrase “replicating a write request” may mean replicating the user data that is part of the write request.

In some embodiments, the term “I/O request” or simply “I/O” may be used to refer to an input or output request. At least some of the steps discussed with respect to FIGS. 1-5 may be performed in a different order or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. The acronym RAID, as used throughout the disclosure, means “Redundant Array of Independent Disks”.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
receiving write requests at a first storage system;
destaging the write requests to a permanent storage of the first storage system and collecting one or more destage statistics that are associated with the write requests;
generating a hint object corresponding to the write requests, the hint object being generated based at least in part on the destage statistics;
transmitting the hint object to a second storage system; and
transmitting at least some of the write requests to the second storage system for remote replication.

2. The method of claim 1, wherein the hint object includes an indication of a relocation probability for the write requests.

3. The method of claim 1, wherein the hint object includes an indication of an expected compression rate for the write requests.

4. The method of claim 1, wherein the hint object includes an indication of a probability of deduplication for the write requests.

5. The method of claim 1, wherein the hint object includes an indication of whether the write requests are part of random write pattern or a sequential write pattern.

6. The method of claim 1, further comprising destaging the transmitted write requests at the second storage system based on the hint object.

7. The method of claim 6, wherein destaging the transmitted write requests at the second storage system includes identifying a relocation probability based on the hint object and selecting, based on the relocation probability, one of a relocation-write and an in-place write as a method for destaging the transmitted write requests at the second storage system.

8. The method of claim 6, wherein destaging the transmitted write requests at the second storage system includes identifying, based on the hint object, an expected compression rate for the transmitted write requests, and detecting whether to use data compression when destaging the transmitted write requests at the second storage system, the detecting being performed based on the expected compression rate for the write requests.

9. The method of claim 6, wherein destaging the transmitted write requests at the second storage system includes identifying, based on the hint object, a probability of deduplication for the transmitted write requests and detecting whether to use a deduplication path or a non-deduplication path for destaging the transmitted write requests at the second storage system, the detecting being performed based on the probability of deduplication for the write requests.

10. The method of claim 6, wherein destaging the transmitted write requests at the second storage system includes identifying, based on the hint object, when the transmitted write requests are associated with a random write pattern or a sequential write pattern and selecting one of a relocation-write and an in-place write as a method for destaging the write requests at the second storage system, the selection being made based on whether the transmitted write requests are associated with a random write pattern or a sequential write pattern.

11. The method of claim 6, wherein destaging the transmitted write requests at the second storage system based on the hint object includes using a machine-learning model to generate another hint object based on the hint object and destaging the transmitted write requests based on the other hint object.

12. A system, comprising:
a memory; and
at least one processor that is operatively coupled to the memory, the at least one processor being configured to perform the operations of:
receiving write requests at a first storage system;
destaging the write requests to a permanent storage of the first storage system and collecting one or more destage statistics that are associated with the write requests;
generating a first hint object corresponding to the write requests, the first hint object being generated based at least in part on the destage statistics;
transmitting the hint object to a second storage system; and
transmitting the write requests to the second storage system for remote replication.

13. The system of claim 12, wherein the hint object includes an indication of a relocation probability for the write requests.

14. The system of claim 12, wherein the hint object includes an indication of an expected compression rate for the write requests.

15. The system of claim 12, wherein the hint object includes an indication of a probability of deduplication for the write requests.

16. The system of claim 12, wherein the hint object includes an indication of whether the write requests are part of random write pattern or a sequential write pattern.

17. A system, comprising:
a memory; and
at least one processor that is operatively coupled to the memory, the at least one processor being configured to perform the operations of:
receiving write requests from a source storage system, the write request being received for the purpose of data replication;
receiving, from the source storage system, a first hint object that is associated with the write requests; and
destaging the write requests based on the first hint object.

18. The system of claim 17, wherein destaging the write requests includes identifying a relocation probability based on the first hint object and selecting, based on the relocation probability, one of a relocation-write and an in-place write as a method for destaging the write requests.

19. The system of claim 17, wherein destaging the write requests includes identifying, based on the first hint object, an expected compression rate for the write requests, and detecting whether to use data compression when destaging the write requests, the detecting being performed based on the expected compression rate for the write requests.

20. The system of claim 17, wherein destaging the write requests includes using a machine-learning model to generate a second hint object based on the first hint object and destaging the requests based on the second hint object.
